(19) United States
(12) Patent Application Publication
(10) Pub. No.: US 2008/0261836 A1
(43) Pub. Date: Oct. 23, 2008

(54) Compositions for use in well servicing fluids

(76) Inventors: Paul A. Filler, Calcasieu Parish, LA (US); Wayne L. Sorensen, Calcasieu Parish, LA (US); Kip D. Sharp, Calcasieu Parish, LA (US)

Correspondence Address: C. JAMES BUSHMAN, 5718 WESTHEIMER, SUITE 1800, HOUSTON, TX, 77057, US

(21) Appl. No.: 11/788,816

(22) Filed: Apr. 20, 2007

(51) Int. Cl. C09K 8/035

(52) U.S. Cl. 507/260

(57) ABSTRACT

A composition useful in a well servicing fluid comprising a base fluid, comprising from 5-40 wt. % paraffins, from 5-40 wt. % olefins, from 5-20 wt. % naphthenes, from 5-20 wt. % esters, and from 2-10 wt. % oxygenates comprising primarily alcohols and ethers, the base fluid being useful as an additive alone or in conjunction with at least one other component typically used in well servicing fluids such as drilling fluids, workover fluids, packer fluids, etc.

### FIELD OF THE INVENTION

The present invention relates to well servicing or wellbore fluids and, more particularly, to such fluids which exhibit low toxicity to marine life and high biodegradability.

### BACKGROUND OF THE INVENTION

In the drilling for and recovering of oil and gas from subterranean formations, a wide variety of fluids are employed, non-limiting examples of such fluids including drilling fluids, commonly referred to as drilling muds, completion fluids, stimulation fluids, packer fluids, displacement fluids, workover fluids, fracturing fluids, chemical flooding fluids and spotting fluids. These various fluids, some of which have very similar compositions, serve specific needs as their respective names indicate.

The prior art abounds with numerous patents and publications related to the compositions of such fluids and their methods of use in the drilling for and recovering of oil and gas. While stringent EPA guidelines and permits apply to compositions and methods used in the drilling for and recovering of oil and gas whether the well be onshore or offshore, because of the high costs associated with proper disposal or handling of wellbore solids in spent or used fluids from offshore operations, intense efforts in the oil and gas industry have focused on the development of well servicing fluids which have high biodegradability and low marine life toxicity so that, in at least some cases, the disposal of the recovered solids into offshore waters poses no environmental or ecological problems.

This disposal problem in offshore waters is highlighted with respect to drilling mud. As is well known to those skilled in the art, the drilling mud or fluid performs many functions such as transporting drill cuttings up the wellbore and permitting their separation at the surface allowing the drilling fluid to be reused. Additionally, the drilling mud serves to cool and clean the bit, reduce friction between the drill pipe and the borehole, maintain the stability of the uncased sections of the borehole against cave-in, sloughing, etc.

Drilling muds are generally classified as either water-based muds or oil-based muds, depending upon the character of the continuous phase of the mud, although water-based muds may contain an oil and oil-based muds may contain water.

Water-based muds conventionally comprise a hydratable clay suspended in water and also typically includes surfactants, emulsifiers and other additives, including salts, pH control agents, weighting agents, etc. The water makes up the continuous phase of the mud and is usually present in an amount of at least 50 wt. % of the entire composition. Oil may be present in minor amounts but will typically not exceed the amount of water so that the mud will retain its character as a water-continuous phase composition.

Oil-based muds on the other hand, generally use a hydrocarbon oil as the main liquid component or continuous phase with other materials such as clays or colloidal asphalts added to provide the desired viscosity together with emulsifiers, gelants and other additives including weighting agents. Water may be present in greater or lesser amounts but will usually not be greater than 50% of the entire composition. If more than 10% water is present, the mud is often referred to as an invert emulsion, i.e., a water-in-oil emulsion. In invert emulsions, the amount of water is typically up to 40 wt. % with the oil, the continuous phase, and the additives making up the remainder of the fluid.

Water based drilling fluids may be suitable for drilling in certain types of formations; however, for proper drilling in other formations, it is desirable to use a non-aqueous drilling fluid, i.e., a oil based mud. With an oil based mud, the cuttings, besides ordinarily containing moisture, are necessarily coated with an adherent film or layer of oleaginous drilling fluid, which may penetrate into the interior of the cuttings. This is true despite the use of various vibrating screens, mechanical separation devices, and various chemical and washing techniques. Currently, in outer continental shelf waters of the United States, cutting's drilled using diesel-based and mineral oil-based non-aqueous drilling fluids cannot be discharged and therefore require an alternate method of disposal in order to meet regulatory requirements, most of which are more expensive and more inconvenient than discharge of water based drilling fluids. Furthermore even in the case of water based drilling fluids, and as noted above, there may be sufficient oil/hydrocarbon present that even disposal of wellbore solids in water based drilling muds poses a toxicity and/or other ecological problem.

To overcome the disposal problem in offshore drilling operations, particularly those involving non-aqueous or oil-based drilling fluids, numerous compositions have been proposed primarily based on the use of hydrocarbons which are biodegradable, exhibit low marine toxicity and, in general, are environmentally friendly whether used in land-based or offshore-based operations. Again, while the problem manifests itself, particularly in offshore operations, primarily in respect of solids recovered from drilling fluids, it can also be a problem with respect to any well servicing fluid, oil-based or water-based, which is intended for reuse once cuttings, debris, etc., from the wellbore are removed.

### SUMMARY OF THE INVENTION

In one aspect, the present invention provides a base fluid for use in oil servicing fluids comprising from 5-40 wt. % paraffins, from 5-40 wt. % olefins, from 5-20 wt. % naphthenes, from 5-20 wt. % esters, and from 2-10 wt. % oxygenates comprising primarily alcohols and ethers.

In another aspect of the present invention, there is provided a well servicing fluid comprising the base fluid described above and at least one component selected from the group consisting of

(1) an additive used in drilling fluids;

(2) an additive used in completion fluids;

(3) an additive used in stimulation fluids;

(4) an additive used in packer fluids;

(5) an additive used in displacement fluids;

(6) an additive used in workover fluids;

(7) an additive used in fracturing fluids;

(8) an additive used in chemical flooding fluids; and

(9) an additive used in spotting fluids.

The foregoing objects, features and advantages of the present invention, as well as others, will be more fully understood and better appreciated by reference to the following specification and claims.

### DETAILED DESCRIPTION OF PREFERRED EMBODIMENTS

The present invention is primarily based upon the use of a unique composition of matter which, alone or in admixture with other components, can be used in a well servicing or wellbore fluid. Non-limiting examples of such well servicing fluids include drilling fluids, completion fluids, stimulation fluids, packer fluids, displacement fluids, workover fluids, fracturing fluids, chemical flooding fluids, spotting fluids, etc.

The base fluid of the present invention, referred to hereafter as Base Fluid A, is a fraction of a by-product stream obtained from a Ziegler ethylene chain growth reaction process. As is well known, as part of the manufacturing process for the production of aluminum alkoxides, an isoparaffin stream as, for example, an isoparaffin stream identified as CAS 64742-47-8, is admixed with an aluminum alkyl stream as a carrier or process solvent. The aluminum alkyl stream is obtained by the Ziegler ethylene chain growth reaction process well known to those skilled in the art. During this ethylene growth step, the alkyl chains on the aluminum become longer and some by-product olefins are created. After growth, the material is sent to an oxidation step where the aluminum alkyls are converted to aluminum alkoxides with the concomitant production of some oxygenated by-products.

This solvent/olefin/oxygenate/aluminum alkoxide stream is then sent to a stripper where the non-alkoxide components are removed as an overhead stream. This overhead is typically denoted as a solvent stripper overhead (SSO). A fraction of this SSO material is removed from the stripper column, the removed material having a flash point of from 140-210° F. The removed material is Base Liquid A and contains from 5-40 wt. % paraffins, from 5-40 wt. % olefins, from 5-20 wt. % naphthenes, from 5-20 wt. % esters and from 2-10 wt. % oxygenates, the oxygenates being primarily alcohols and ethers. With respect to the individual components, the paraffins comprise at least 75 wt. % of C₁₀-C₂₄ linear and branched chain paraffins, the olefins comprising at least 75 wt. %, more generally greater than 85 wt. % C₁₀-C₂₂ olefins, the olefins being a mixture of pendant, internal and alpha olefins. The naphthenes contain at least 90 wt. % C₁₀-C₁₄ naphthenes. The esters comprise at least 90 wt. % C₆-C₃₆ esters. The remaining oxygenates comprise 2-7 wt. % alcohols, at least 90% being C₆-C₁₄ primary, linear alcohols, and from greater than 0 to 3 wt. % ethers.

As can be seen from the above, Base Liquid A is a single source material in that it comprises a specific fraction of the SSO described above. Base Liquid A is comprised of greater than 95 wt. % linear compounds except for the branched paraffins and naphthenes present in Base Liquid A. Base Liquid A is also characterized by being substantially free of aromatics like benzene, toluene, ethylbenzene and xylenes (BTEX) and, in fact, tests have shown that the (BTEX) content is at nondetectable levels (<1.5 ppm).

Base Liquid A, as noted above, can be used as a component of oil based or water based drilling fluids as well as a component of other well servicing or wellbore fluids mentioned above. In particular, the ready biodegradability and low toxicity of Base Liquid A vis-à-vis marine life make it an ideal fluid to use in well servicing fluids used in offshore oil and gas drilling and producing operations. In the case of drilling fluids whether oil based or water based, a number of other, well known additives in addition to Base Liquid A can be employed. Non-limiting examples of such additives include esters, emulsifiers, surfactants, viscosity-modifying agents, weighting agents, clays, salts such as sodium chloride, calcium chloride, calcium bromide, pH control agents, circulation control agents such as shredded cellulosic materials, filtration control reagents, wetting agents, etc. Depending upon whether the drilling mud is oil based or water based the amount of Base Liquid A in will vary significantly. Typically in muds of the invert emulsion type, the amount of Base Liquid A can range from 20-75 wt. % whereas in water-based muds it would generally be used in an amount of up to 50 wt. %, the other components being water and the various additives being described above.

The drilling muds, whether oil based or water based described above, can also be used as spotting fluids, particularly in the case of water-based drilling muds. In this regard and as is well known to those skilled in the art, there are occasions during the drilling operation when the drill string may develop unacceptable rotational torque or, in a worst case scenario, become stuck. When this happens, the drill string cannot be raised, lowered or rotated. Common factors leading to this situation include (1) cuttings or slough buildup in the borehole; (2) an undergauge borehole; (3) irregular borehole development embedding a section of the drill pipe into the drilling mud wall cake; and (4) unexpected differential formation pressure. Differential pressure sticking occurs when the drill pipe becomes embedded in the wall mud cake opposite a permeable zone. The difference between (a) the hydrostatic pressure in the drill pipe, and (b) the formation pressure holds the pipe in place, resulting in pipe sticking. In the case of a stuck drill pipe, a drill mud, oil based or water based, especially one with a water-based surfactant composition can be used to free the drill pipe by reducing friction, permeating the drilling mud wall cake, destroying binding wall cake and reducing differential pressure. Thus, a spotting fluid typically contains one or more additives typically used in drilling muds and may also contain surfactants for the purposes set out above. It will be understood, however, that spotting fluids in a given drilling environment may differ from the actual drilling mud in that it contains different types and/or amounts of additives designed at freeing the pipe.

It is also common in drilling muds, particularly oil-based drilling muds, e.g., invert emulsion muds, to employ esters in addition to the hydrocarbon or oil phase making up the continuous phase of the invert emulsion mud. In particular, the use of natural esters in invert emulsion drilling muds has found widespread use. Non-limiting examples of such esters are disclosed, for example, in U.S. Pat. Nos. 5,106,516; 5,232,910; 5,318,954; and RE36,066, all of which are incorporated herein by reference for all purposes. In addition to the esters set forth in those patents, the prior art abounds with patents directed to the use of other esters which have high biodegradability and low marine toxicity.

Completion fluids are employed once the drilling operation has been terminated. Completion fluids, often used as packer fluids, are frequently solids-free and are used to balance the pressure exerted by the earth formation, i.e., maintain hydrostatic pressure in the well higher than that of the formation. Solids-free completion fluids are often used as packer fluids as is well know to those skilled in the art. Completion fluids can be substantially aqueous compositions containing little or no oil or can contain minor amounts of hydrocarbons together with additives typically used in completion fluids such as various polymers, salts of polymers, gelling agents, liqnite, liqnolsulfonates, defoamers, etc. The composition of the completion fluid will depend upon the nature of the formation and numerous types and amounts of additives can be employed to tailor the completion fluid.

Spacer fluids which can be considered a type of completion fluid in the sense that they are used to displace existing fluids out from at least a portion of the wellbore can be either an aqueous fluid such as water or a hydrocarbon based material again depending upon the nature of the well, cost factors, etc. The use of such spacer fluids is disclosed in U.S. Pat. No. 4,530,402, incorporated herein by reference for all purposes.

Although well stimulation fluids are primarily aqueous in nature, occasions may arise when a hydrocarbon such as Base Liquid A could be used in a well stimulation fluid.

Displacement fluids, sometimes referred to as spacer fluids, are commonly used when it becomes necessary during the drilling operation to change the type of mud. For example, for shallow drilling, water-based muds can typically be employed while as the borehole depth increases and the formations change, the formation pressure and heat generated by the drill bit also changes. Accordingly, eventually a mud of greater weight has to be employed for the deeper formations and it is typical to switch to water-in-oil emulsions or invert drilling muds to continue the drilling. This switching from one mud to another mud is generally accomplished by the use of a displacement fluid or spacer fluid which is typically injected into the drill string behind the mud in use and in front of the new mud to be used. The spacer fluid acts to provide a physical barrier between the different types of mud while also serving to clean the hardware of the old mud. Displacement fluids are also used prior to cementing to displace the drilling mud in the drill string and the casing prior to the cement being pumped down the casing. Again, the displacement fluid acts as a physical barrier between the mud and the cement and cleans the hardware to avoid contaminating the cement with the mud. Many displacement or spacer fluids are water-based but it is common for a displacement fluid to comprise an aqueous continuous phase essentially 100 wt. % aqueous, to immediately above the point at where an emulsion inverts from oil-in-water to a water-in-oil. This lower point will vary depending upon the particular ingredients and/or amounts used in the displacement fluid composition. Additives used in displacement fluids includes surfactants as well as many other additives mentioned above with respect to the other well servicing fluids mentioned. Typical displacement fluids are disclosed, for example, in U.S. Pat. No. 6,063,737, incorporated herein by reference for all purposes.

Workover fluids also referred to as completion fluids can also, as in the case with completion fluids and spacer fluids, be comprised of an oil-based component together with additives commonly used in such fluids and well known to those skilled in the art.

In chemical flooding, the chemical flooding agents are used, like fracturing fluids and other simulation fluids, to increase the production of oil from subterranean reservoirs. The majority of chemical flooding fluids comprise water-based, viscosified surfactant solutions which can contain various additives, e.g., polymers, emulsifiers, and other such agents commonly used in enhanced oil recovery operations. As well, there are occasions when chemical flooding fluids can incorporate a hydrocarbon oil for particular purposes.

Fracturing fluids, commonly referred to as frac fluids, can employ hydrocarbon or oil as, for example, linear olefins, particularly alpha olefins as disclosed in U.S. Pat. No. 5,674,816 incorporated herein by reference for all purposes. As taught in that patent, the selection of an appropriate frac fluid is not easy and various condensates containing aromatics and alkanes, diesel, crude oil, etc., have been used. Thus, while fracturing fluids are typically light brines containing cross linked polysaccharide polymers, frac fluids of widely varying composition including those employing hydrocarbons are used as well. Common additives employed in conventional frac fluids include cross linked gel stabilizers, propants as well as numerous other additives such as those mentioned above with respect to the other well servicing fluids discussed above.

As can be seen from the above discussion, many of the well servicing fluids enumerated above can be essentially the same composition, their name being primarily dependent upon the use to which they are put. For example, completion fluids can also be workover fluids and vise versa, spotting fluids can be drilling fluids, etc. As can also be seen above, the number, type and amount of additives that can be employed is myriad. Also, the amount of a hydrocarbon or oil such as Base Fluid A used in such fluids can vary widely. As noted, many of the fluids mentioned above, are primarily aqueous or water-based and in many cases are essentially, except for certain additives, 100% aqueous. However, it is also noted that, even in the case of well servicing fluids which are generally 100% aqueous in nature vis-à-vis their liquid composition, in many cases as taught in certain of the patents cited above, they have or can have a hydrocarbon component.

To demonstrate the biodegradability and non-toxic nature of Base Fluid A, several, well known and accepted tests were conducted.

### Toxicity

### EXAMPLE 1

Base Liquid A when tested in a generic #7 drilling fluid at a 3 wt. % concentration has a nice margin of safety. US EPA SPP 96-hr LC 50 test (Mysidopsis bahia) defines a passing result as 30,000 ppm SPP (suspended particulate phase). Base Liquid A passes this test at 250,000 ppm SPP.

### EXAMPLE 2

There are applications where EPA requirements mandate the use of a compliant synthetic base fluid. Base Liquid A can be safely blended with esters to pass the Leptocheirus Plumulosus acute static 10-day sediment toxicity test. When Base Liquid A is blended with OMC 586¹ ester at 50 wt. %, the blend achieves a passing score with some margin for safety. The general permit (GMG 290000) defines a passing synthetic base fluid as follows:

$$\frac{{C}_{16} - {C}_{18} internal olefin reference standard 10 \text{-} day LC 50}{test sample 10 \text{-} day LC 50} \leq 1$$

It was found that base fluid A when blended with OMC 586 ester passed at a ratio of 0.6. ¹OMC 586 ester is a mixture of fatty acid esters with an average mw of 312 marketed by Cognis.

### Biodegradability

### EXAMPLE 3

Biodegradation tests run according to OECD 301F guidelines, show that Base Liquid A rapidly and extensively biodegrades (half life of 4.6 days) and meets the “ready” biodegradability requirement of at least 60 theoretical carbon dioxide (ThCO₂) generation in the 10-day window>60% THCO₂ (75% actual) after 28 days.

It can be seen from the above that well servicing fluids using Base Liquid A, alone or in combination with other additives, typically used in well servicing fluids can be formulated into a broad range of well servicing fluids particularly desirable in sensitive ecological areas such as offshore drilling.

The foregoing description and examples illustrate selected embodiments of the present invention. In light thereof, variations and modifications will be suggested to one skilled in the art, all of which are in the spirit and purview of this invention.

What is claimed is:

1. A composition comprising:
(A) a base fluid comprising from 5-40 wt. % paraffins, from 5-40 wt. % olefins, from 5-20 wt. % naphthenes, from 5-20 wt. % esters and from 2-10 wt. % oxygenates comprising primarily alcohols and ethers, and
(B) at least one component used in a well servicing fluid.

2. The composition of claim 1, wherein said at least one component is selected from the group consisting of
(1) an additive used in drilling fluids;
(2) an additive used in completion fluids;
(3) an additive used in stimulation fluids;
(4) an additive used in packer fluids;
(5) an additive used in displacement fluids;
(6) an additive used in workover fluids;
(7) an additive used in fracturing fluids;
(8) an additive used in chemical flooding fluids; and
(9) an addictive used in spotting fluids.

3. The composition of claim 1, wherein said paraffins comprise at least 75 wt. % C10-C24 linear and branched chain paraffins.

4. The composition of claim 1, wherein said olefins comprise at least 75 wt. % C10-C22 olefins.

5. The composition of claim 1, wherein said naphthenes comprise at least 90 wt. % C10-C14 naphthenes.

6. The composition of claim 1, wherein said esters comprise at least 90 wt. % C6-C36 esters.

7. The composition of claim 1, wherein said oxygenates comprise from 2-7 wt. % alcohols and from greater than 0-3 wt. % ethers, said alcohols comprising at least 90 wt. % C₆-C₁₄ primary, linear alcohols.

8. The composition of claim 1, wherein greater than 95 wt. % of said olefins, said esters and said oxygenates are linear.

9. The composition of claim 1, wherein said base fluid is substantially free of benzene, toluene, xylene, and ethylbenzene (BTEX).

10. The composition of claim 9, wherein said aromatics are present in an amount of less than 1.5 ppm.

11. The composition of claim 1, wherein said base fluid is a fraction of a by-product stream obtained from a Ziegler ethylene chain growth reaction process.

12. The composition of claim 11, wherein said fraction has a flash point of from about 140 to about 210° F.

13. A composition useful in formulating well servicing fluids comprising:
a base fluid comprising from 5-40 wt. % paraffins, from 5-40 wt. % olefins, from 5-20 wt. % naphthenes, from 5-20 wt. % esters, and from 2-10 wt. % oxygenates comprising primarily alcohols and ethers.
